(19) United States
(12) Patent Application Publication
(10) Pub. No.: US 2013/0226505 A1
(43) Pub. Date: Aug. 29, 2013

(54) Dual Accelerometer Plus Magnetometer Body Rotation Rate Sensor-Gyrometer

(71) Applicant: mCube, Incorporated, (US)

(72) Inventors: Joe Kelly, Center Point, IA (US); John Acheson, Marion, IA (US)

(73) Assignee: mCube, Incorporated, San Jose, CA (US)

(21) Appl. No.: 13/758,381

(22) Filed: Feb. 4, 2013

Related U.S. Application Data
(60) Provisional application No. 61/594,336, filed on Feb. 2, 2012.

(51) Int. Cl. G01C 19/02

(52) U.S. Cl. CPC G01P 9/02
USPC 702/141

(57) ABSTRACT

A computer-system implemented method for determining gyroscopic rotation data, implemented on a computer system programmed to perform the method includes determining in one or more accelerometers of the computer system, accelerometer data in response to a physical manipulation of the computer system, determining in a magnetometer of the computer system, magnetometer data in response to the physical manipulation of the computer system, and determining in the processor of the computer system, a gyroscopic rotation of the computer system in response to the accelerometer data and to the magnetometer data.

### CROSS REFERENCE TO RELATED APPLICATIONS

The present application is a non-provisional of 61/594,336 filed Feb. 2, 2012 and incorporates it by reference, for all purposes.

### BACKGROUND OF THE INVENTION

The present invention relates to the field of smart devices. More specifically, the present invention relates to determining rotational manipulations of such smart devices.

Three-axis gyroscopes have been useful for determining rotations of hand-held devices about three-axes. The inventors of the present invention have determined that there are several drawbacks to the use of such gyroscopes in hand-held devices to determine rotations. One such drawback is that gyroscopes are often power hungry devices that require relatively large operating power, compared to other MEMS devices, such as accelerometers. Another drawback is that gyroscopes are relatively expensive compared to other MEMS devices. Although many current smart-devices, e.g. phones, tablets, etc. include such gyroscopes, it is believed that for emerging markets, more cost-effective and efficient smart-devices are desired.

In light of the above, what is desired are methods and apparatus that address the issues described above.

### BRIEF SUMMARY OF THE INVENTION

The present invention relates to the field of smart devices. More specifically, the present invention relates to determining rotational manipulations of such smart devices.

The present invention relates to the field of smart devices. More specifically, the present invention relates to determining rotational of such smart devices without relying upon MEMS-based gyroscopes. In particular, embodiments of the present include utilizing acceleration data from one or more accelerometers, and magnetic field data from a magnetometer of the smart device to compute rotational manipulation of the smart device. In various embodiments, such acceleration data and magnetic field data are combined with known geometry of the accelerometers/magnetometer within the smart device. In some embodiments, the distances and directions of the accelerometers and magnetometer with respect to each other, a center of gravity, or the like may be used in the computations.

According to one aspect of the invention, a computer-system implemented method for determining gyroscopic rotation data, implemented on a computer system programmed to perform the method is disclosed. One technique includes determining in one or more accelerometers of the computer system, accelerometer data in response to a physical manipulation of the computer system, and determining in a magnetometer of the computer system, magnetometer data in response to the physical manipulation of the computer system. A process includes determining in the processor of the computer system, a gyroscopic rotation of the computer system in response to the accelerometer data and to the magnetometer data.

According to one aspect of the invention, a mobile computer-system for determining rotation data is disclosed. An apparatus includes one or more accelerometers configured to determine accelerometer data in response to a physical manipulation of the mobile computer system, and a magnetometer configured to determine magnetometer data in response to the physical manipulation of the mobile computer system. A device includes a processor coupled to the one or more accelerometers and to the magnetometer, wherein the processor is programmed to determine a rotation of the mobile computer system in response to the accelerometer data ad to the magnetometer data.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 illustrates a block diagram of a process according to various embodiments of the present invention;

FIG. 2 illustrates a block diagram of additional embodiments of the present invention; and

FIG. 3 illustrates a representative computing device capable of embodying the present invention.

### DETAILED DESCRIPTION OF THE INVENTION

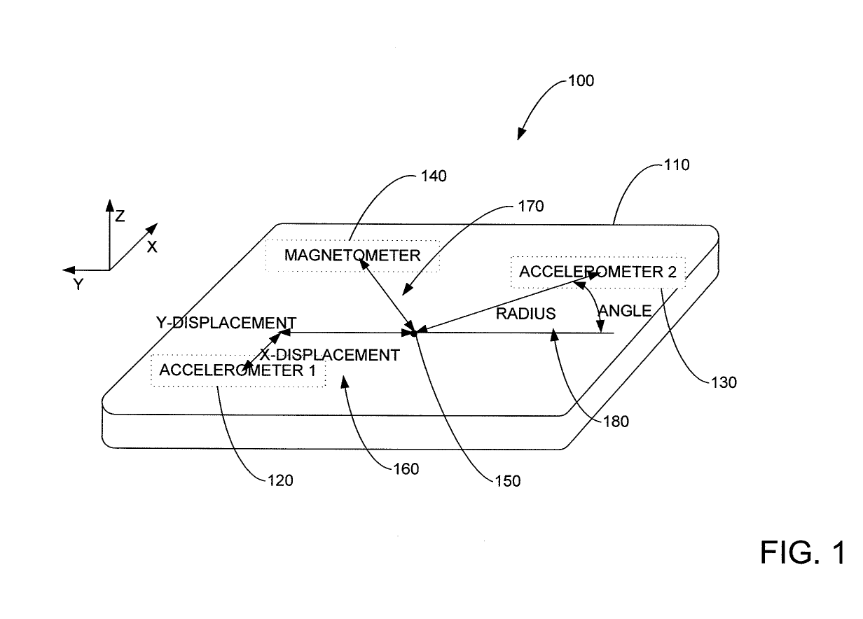

FIG. 1 illustrates a functional block diagram according to various embodiments of the present invention. More specifically, FIG. 1 illustrates a device 100, e.g. smart phone, or the like, having a body 110.

Within device 100 MEMs-based accelerometers 120 and 130 and magnetometer 140 are included. As shown, a reference point 150 is identified within device 100. In some embodiments, point 150 may be a computed center-of gravity, an axis of rotation, or the like.

In various embodiments, offsets, displacements or the like 160, 170 and 180 are respectively is determined between point 150 and accelerometer 120, accelerometer 130, and magnetometer 140. In some embodiments, offsets 160, 170 and 180 may be computed during the design phase, production phase, or the like. In some embodiments, offsets 160, 170 and 180 can be stored within a memory of device 100 and used for the computations described below. In other embodiments, one or more look-up-tables may be used that receive offsets 160, 170 and 180 and output the results of the computations below. In some embodiments, offsets 160, 170 and 180 may be referenced by x, y and z coordinates, and in other embodiments, polar coordinates may also be used. In some embodiments, the offset 180 of the magnetometer 140 need not be used.

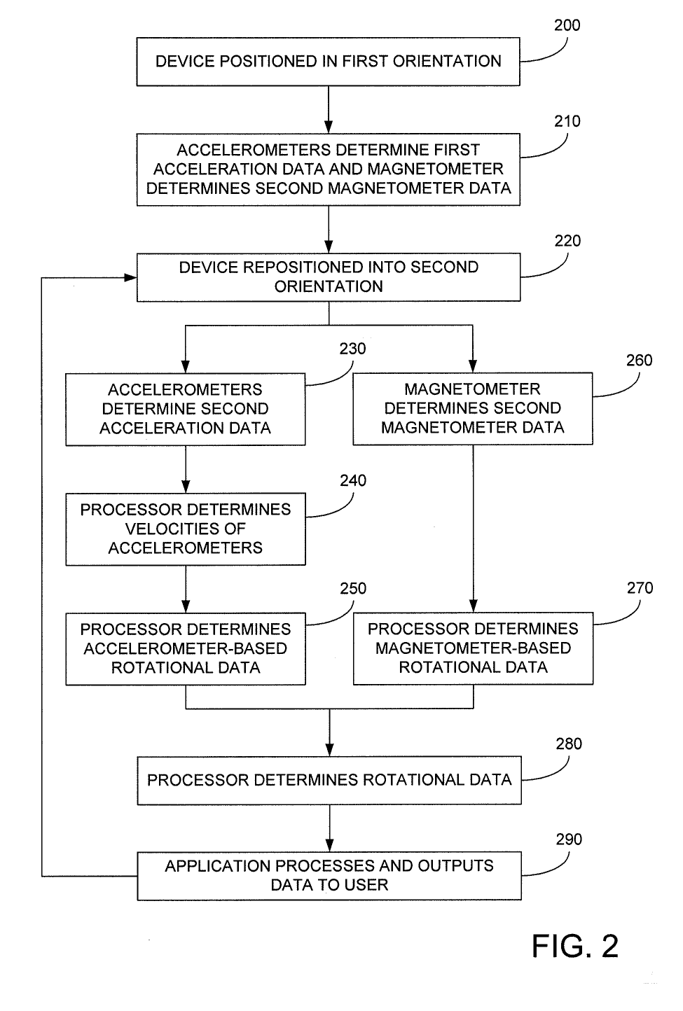

FIG. 2 illustrates a block diagram of a process according to various embodiments of the present invention.

In various embodiments, steps 230-250 and steps 260-270 may be performed independently of each other. In some embodiments, these steps may be performed in parallel, parallel processor threads, sequentially, or the like. Accordingly, the timing of steps 230-250 with respect to steps 260-270 are not limited in various embodiments.

Initially, a device described in FIG. 1 is oriented in a first orientation, step 200. In various embodiments, while in that first orientation, typically in a rest position, the acceleration data from the accelerometers will typically primarily reflect the direction of gravity; and magnetometer data from the magnetometer will typically reflect the Earth magnetic field, step 210.

Next, in various embodiments, the device may be subject to one or more orientations (e.g. rotations) in space, step 220. In response to these physical perturbations of the device, the accelerometers provide updated accelerometer data, typically reflecting the new direction of gravity while in the new orientation, typically at the next sampling time cycle, step 230. Further, the magnetometer provides updated magnetometer data, typically reflecting the new direction of the Earth magnetic field while in the new orientation, typically at the next sampling time, step 260. In various embodiments, these accelerometer and magnetometer data may be stored for subsequent use.

In various embodiments, the updated accelerometer data is provided to a processor, LUT, or the like, of the device, which in turn determines a velocity of the first accelerometer and a velocity of the second accelerometer, relative to the accelerometer data determined in step 210, step 240. In various embodiments, the respective velocities may be determined by comparing the acceleration data determined in step 210 and 230 relative to the sampling time.

Next, in various embodiments, the respective velocities of the accelerometers and the offsets or displacements of the accelerometers, discussed above, may be used to determine an accelerometer-based relative rotation rate, step 250. As an example of this, at rest, a left and right accelerometers may sense 1 G in a downward direction. Next, during a physical perturbation, the left accelerometer may sense 0.5 G in a downward direction, and the right accelerometer may sense 1.5 G in an upward direction. Accordingly, in this example, the accelerometer computed rotation may appear to be a counter-clock-wise movement around an x-axis.

In various embodiments, the updated magnetometer data of the magnetometer (step 260) and the previous magnetometer data (e.g. in step 210) (and optionally offset 180) are used to determine a magnetometer computed rotation rate, step 270, relative to the sampling time. As an example of this, at rest, the magnetometer initially senses magnetic north at 90 degrees, and subsequently at the next sampling time, senses magnetic north at 0 degrees. In this example, the magnetometer computed rotation may appear to be a clock-wise rotation about a z-axis.

In light of the present patent disclosure, one of ordinary skill in the art would recognize that many different ways to determine rotational data in steps 250 and 270 are contemplated within various embodiment of the present invention.

In various embodiments, the accelerometer-based rotational data and the magnetometer-based rotational data may be combined to determine improved rotational data, step 280. In some embodiments, the accelerometer and magnetometer-based rotational data may be processed in a number of ways, include differencing, or the like to determine the improved rotational data. In light of the present patent disclosure, one of ordinary skill in the art would recognize that many different ways to weight or combine the rotational data determined in steps 250 and 270.

In various embodiments, the rotational data determined in step 280 is provided as inputs into one or more applications running upon the device, and the one or more applications may output data to the user based upon the inputs, step 290. In some embodiments, the user output may be an audio alarm, recording of data, displaying of icons on a display, sending a wireless transmission (e.g. tweet, SMS, telephone call), or the like.

In various embodiments, the process described above may be repeated using data determined in steps 230 and 260 as the “first orientation” data of step 210.

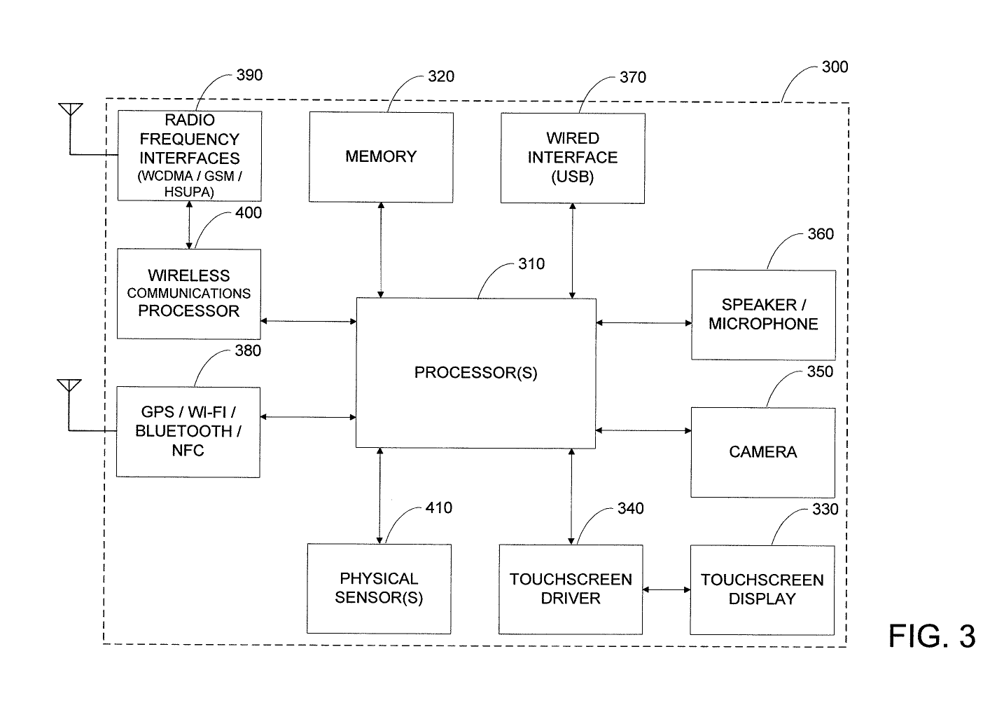

FIG. 3 illustrates a functional block diagram of various embodiments of the present invention. In FIG. 3, a computing device 300 typically includes an applications processor 310, memory 320, a touch screen display 330 and driver 340, an image acquisition device 350, audio input/output devices 360, and the like. Additional communications from and to computing device are typically provided by via a wired interface 370, a GPS/Wi-Fi/Bluetooth interface 380, RF interfaces 390 and driver 400, and the like. Also included in various embodiments are physical sensors 410.

In various embodiments, computing device 300 may be a hand-held computing device (e.g. Apple iPad, Apple iTouch, Dell Mini slate, Lenovo Skylight/IdeaPad, Asus EEE series, Microsoft Courier, Samsung Galaxy Tab, Android Tablet), a portable telephone (e.g. Apple iPhone, Motorola Droid series, Google Nexus S, HTC Sensation, Samsung Galaxy S series, Palm Pre series, Nokia Lumina series), a portable computer (e.g. netbook, laptop, ultrabook), a media player (e.g. Microsoft Zune, Apple iPod), a reading device (e.g. Amazon Kindle Fire, Barnes and Noble Nook), or the like.

Typically, computing device 300 may include one or more processors 310. Such processors 310 may also be termed application processors, and may include a processor core, a video/graphics core, and other cores. Processors 310 may be a processor from Apple (A4/A5), Intel (Atom), NVidia (Tegra 3, 4), Marvell (Armada), Qualcomm (Snapdragon), Samsung, TI (OMAP), or the like. In various embodiments, the processor core may be an Intel processor, an ARM Holdings processor such as the Cortex-A, -M, -R or ARM series processors, or the like. Further, in various embodiments, the video/graphics core may be an Imagination Technologies processor PowerVR-SGX, -MBX, -VGX graphics, an Nvidia graphics processor (e.g. GeForce), or the like. Other processing capability may include audio processors, interface controllers, and the like. It is contemplated that other existing and/or later-developed processors may be used in various embodiments of the present invention.

In various embodiments, memory 320 may include different types of memory (including memory controllers), such as flash memory (e.g. NOR, NAND), pseudo SRAM, DDR SDRAM, or the like. Memory 320 may be fixed within computing device 300 or removable (e.g. SD, SDHC, MMC, MINI SD, MICRO SD, CF, SIM). The above are examples of computer readable tangible media that may be used to store embodiments of the present invention, such as computer-executable software code (e.g. firmware, application programs), application data, operating system data or the like. It is contemplated that other existing and/or later-developed memory and memory technology may be used in various embodiments of the present invention.

In various embodiments, touch screen display 330 and driver 340 may be based upon a variety of later-developed or current touch screen technology including resistive displays, capacitive displays, optical sensor displays, electromagnetic resonance, or the like. Additionally, touch screen display 330 may include single touch or multiple-touch sensing capability. Any later-developed or conventional output display technology may be used for the output display, such as TFT-LCD, OLED, Plasma, trans-reflective (Pixel Qi), electronic ink (e.g. electrophoretic, electrowetting, interferometric modulating). In various embodiments, the resolution of such displays and the resolution of such touch sensors may be set based upon engineering or non-engineering factors (e.g. sales, marketing). In some embodiments of the present invention, a display output port, such as an HDMI-based port or DVI-based port may also be included.

In some embodiments of the present invention, image capture device 350 may include a sensor, driver, lens and the like. The sensor may be based upon any later-developed or convention sensor technology, such as CMOS, CCD, or the like. In various embodiments of the present invention, image recognition software programs are provided to process the image data. For example, such software may provide functionality such as: facial recognition, head tracking, camera parameter control, or the like.

In various embodiments, audio input/output 360 may include conventional microphone(s)/speakers. In some embodiments of the present invention, three-wire or four-wire audio connector ports are included to enable the user to use an external audio device such as external speakers, headphones or combination headphone/microphones. In various embodiments, voice processing and/or recognition software may be provided to applications processor 310 to enable the user to operate computing device 300 by stating voice commands. Additionally, a speech engine may be provided in various embodiments to enable computing device 300 to provide audio status messages, audio response messages, or the like.

In various embodiments, wired interface 370 may be used to provide data transfers between computing device 300 and an external source, such as a computer, a remote server, a storage network, another computing device 300, or the like. Such data may include application data, operating system data, firmware, or the like. Embodiments may include any later-developed or conventional physical interface/protocol, such as: USB 3.0, 4.0, micro USB, mini USB, Firewire, Apple iPod connector, Ethernet, POTS, or the like. Additionally, software that enables communications over such networks is typically provided.

In various embodiments, a wireless interface 380 may also be provided to provide wireless data transfers between computing device 300 and external sources, such as computers, storage networks, headphones, microphones, cameras, or the like. As illustrated in FIG. 3, wireless protocols may include Wi-Fi (e.g. IEEE 802.11a/b/g/n, WiMax), Bluetooth, IR, near field communication (NFC), ZigBee and the like.

GPS receiving capability may also be included in various embodiments of the present invention, however is not required. As illustrated in FIG. 3, GPS functionality is included as part of wireless interface 380 merely for sake of convenience, although in implementation, such functionality is currently performed by circuitry that is distinct from the Wi-Fi circuitry and distinct from the Bluetooth circuitry.

Additional wireless communications may be provided via RF interfaces 390 and drivers 400 in various embodiments. In various embodiments, RF interfaces 390 may support any future-developed or conventional radio frequency communications protocol, such as CDMA-based protocols (e.g. WCDMA), GSM-based protocols, HSUPA-based protocols, or the like. In the embodiments illustrated, driver 400 is illustrated as being distinct from applications processor 310. However, in some embodiments, these functionality are provided upon a single IC package, for example the Marvel PXA330 processor, and the like. It is contemplated that some embodiments of computing device 300 need not include the RF functionality provided by RF interface 390 and driver 400.

FIG. 3 also illustrates computing device 300 to include physical sensors 410. In various embodiments of the present invention, physical sensors 410 are multi-axis Micro-Electro-Mechanical Systems (MEMS) based devices being developed by M-cube, the assignee of the present patent application. Physical sensors 410 developed by M-cube currently include very low power three-axis sensors (linear, gyro or magnetic); ultra-low jitter three-axis sensors (linear, gyro or magnetic); low cost six-axis motion sensor (combination of linear, gyro, and/or magnetic); ten-axis sensors (linear, gyro, magnetic, pressure); and various combinations thereof.

Various embodiments may include an accelerometer with a reduced substrate displacement bias, as described above. Accordingly, using such embodiments, computing device 300 is expected to have a lower sensitivity to temperature variations, lower sensitivity to production/assembly forces imparted upon to an accelerometer, faster calibration times, lower production costs, and the like.

As described in the patent applications referenced above, various embodiments of physical sensors 410 are manufactured using a foundry-compatible process. As explained in such applications, because the process for manufacturing such physical sensors can be performed on a standard CMOS fabrication facility, it is expected that there will be a broader adoption of such components into computing device 300. In other embodiments of the present invention, conventional physical sensors 410 from Bosch, STMicroelectronics, Analog Devices, Kionix or the like may be used.

In various embodiments, any number of future developed or current operating systems may be supported, such as iPhone OS (e.g. iOS), WindowsMobile (e.g. 7, 8), Google Android (e.g. 4.x, 4.x), Symbian, or the like. In various embodiments of the present invention, the operating system may be a multi-threaded multi-tasking operating system. Accordingly, inputs and/or outputs from and to touch screen display 330 and driver 340 and inputs/or outputs to physical sensors 410 may be processed in parallel processing threads. In other embodiments, such events or outputs may be processed serially, or the like. Inputs and outputs from other functional blocks may also be processed in parallel or serially, in other embodiments of the present invention, such as image acquisition device 350 and physical sensors 410.

FIG. 3 is representative of one computing device 300 capable of embodying the present invention. It will be readily apparent to one of ordinary skill in the art that many other hardware and software configurations are suitable for use with the present invention. Embodiments of the present invention may include at least some but need not include all of the functional blocks illustrated in FIG. 3. For example, in various embodiments, computing device 300 may lack image acquisition unit 350, or RF interface 390 and/or driver 400, or GPS capability, or the like. Additional functions may also be added to various embodiments of computing device 300, such as a physical keyboard, an additional image acquisition device, a trackball or trackpad, a joystick, or the like. Further, it should be understood that multiple functional blocks may be embodied into a single physical package or device, and various functional blocks may be divided and be performed among separate physical packages or devices.

Further embodiments can be envisioned to one of ordinary skill in the art after reading this disclosure. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-system implemented method for determining gyroscopic rotation data, implemented on a computer system programmed to perform the method comprises:
determining in one or more accelerometers of the computer system, accelerometer data in response to a physical manipulation of the computer system;
determining in a magnetometer of the computer system, magnetometer data in response to the physical manipulation of the computer system; and
determining in the processor of the computer system, a gyroscopic rotation of the computer system in response to the accelerometer data and to the magnetometer data.

2. The computer-system implemented method of claim 1 wherein determining in the processor of the computer system, the gyroscopic rotation of the computer system comprises:
determining in a processor of the computer system, a first rotation of the computer system in response to the accelerometer data;
determining in the processor of the computer system, a second rotation of the computer system in response to the magnetometer data; and
determining in the processor of the computer system, a gyroscopic rotation of the computer system in response to the first rotation and to the second rotation.

3. The computer-system implemented method of claim 2, wherein the one or more accelerometers comprises a first accelerometer and a second accelerometer; and
wherein determining in the one or more accelerometers of the computer system, accelerometer data comprises determining in the one or more accelerometers, first accelerometer data associated with the first accelerometer and second accelerometer data associated with the second accelerometer.

4. The computer-system implemented method of claim 3 further comprising:
receiving in the processor of the computer system, physical data associated with the computer system comprising a location of the first accelerometer with respect to the second accelerometer; and
wherein determining in the processor of the computer system, the first rotation comprises determining in the processor of the computer system, the first rotation in response to the first accelerometer data, the second accelerometer data, and the physical data.

5. The computer-system implemented method of claim 2 further comprising:
receiving in the processor of the computer system, physical data associated with the computer system comprising a location of the magnetometer; and
wherein determining in the processor of the computer system, the second rotation comprises determining in the processor of the computer system, the second rotation in response to the magnetometer data and the physical data.

6. The computer-system implemented method of claim 2,
wherein the magnetometer comprises a three-axis magnetometer;
wherein the magnetometer data comprises three-axis magnetometer data; and
wherein the determining in the processor of the computer system, the second rotation of the computer system is in response to the three-axis magnetometer data.

7. The computer-system implemented method of claim 2 further comprising:
determining in the magnetometer of the computer system, an initial Earth magnetic field reading;
determining in the magnetometer of the computer system, a subsequent Earth magnetic field reading in response to the physical manipulation of the computer system; and
wherein the determining in the processor of the computer system, the second rotation of the computer system is in response to the initial Earth magnetic field and to the subsequent Earth magnetic field reading.

8. The computer-system implemented method of claim 2 further comprising:
receiving in the processor of the computer system, a first distance and a first direction associated a first accelerometer with respect to a center of gravity for the computer system; and
wherein the determining in the processor of the computer system, the first rotation of the computer system is also in response to the first distance and the first direction.

9. The computer-system implemented method of claim 2 further comprising:
receiving in the processor of the computer system, a first distance and a first direction associated with the magnetometer with respect to a center of gravity for the computer system; and
wherein the determining in the processor of the computer system, the second rotation of the computer system is also in response to the first distance and the first direction.

10. The computer-system implemented method of claim 9 further comprising:
receiving in the processor of the computer system, a second distance and a second direction associated a first accelerometer with respect to a center of gravity for the computer system; and
wherein the determining in the processor of the computer system, the first rotation of the computer system is also in response to the second distance and the second direction.

11. A mobile computer-system for determining rotation data comprises:
one or more accelerometers configured to determine accelerometer data in response to a physical manipulation of the mobile computer system;
a magnetometer configured to determine magnetometer data in response to the physical manipulation of the mobile computer system;
a processor coupled to the one or more accelerometers and to the magnetometer, wherein the processor is programmed to determine a rotation of the mobile computer system in response to the accelerometer data ad to the magnetometer data.

12. The mobile computer system of claim 11
wherein the processor is programmed to determine a first rotation of the mobile computer system in response to the accelerometer data,
wherein the processor is programmed to determine a second rotation of the mobile computer system in response to the magnetometer data, and wherein the processor is programmed to determine the rotation of the mobile computer system in response to the first rotation and to the second rotation.

13. The mobile computer-system of claim 12,
wherein the one or more accelerometers comprises a first accelerometer and a second accelerometer;
wherein the first accelerometer is configured to determine first accelerometer data;
wherein the second accelerometer is configured to determine second accelerometer data.

14. The mobile computer-system of claim 13, further comprising:
a memory for storing physical data associated with the computer system comprising a location of the first accelerometer and a location of the second accelerometer within the mobile computer system;
wherein the processor is coupled to the memory; and
wherein the processor is programmed to determine the rotation of the mobile computer system in response to the first accelerometer data, the second accelerometer data, and the physical data.

15. The mobile computer system of claim 12
a memory for storing physical data associated with the computer system comprising a location of the magnetometer;
wherein the processor is coupled to the memory; and
wherein the processor is programmed to determine the rotation of the mobile computer system in response to the first rotation, the second accelerometer data, and the physical data.

16. The mobile computer system of claim 12,
wherein the magnetometer comprises a three-axis magnetometer;
wherein the magnetometer data comprises three-axis magnetometer data; and
wherein the processor is programmed to determine the rotation of the mobile computer system response to the three-axis magnetometer data.

17. The mobile computer system of claim 12
wherein the magnetometer is configured to determine a first Earth magnetic field reading at a first time;
wherein the magnetometer is configured to determine a second Earth magnetic field reading at a second time; and
wherein the processor is programmed to determine the second rotation of the computer system in response to the first Earth magnetic field reading and to the second Earth magnetic field reading.

18. The mobile computer-system of claim 12 further comprising:
a memory for storing physical data associated with the computer system comprising a first distance and a first direction with respect to a reference location, associated with an accelerometer from the one or more accelerometers;
wherein the processor is coupled to the memory; and
wherein the processor is programmed to determine the first rotation of the mobile computer system in response to first distance and the first direction.

19. The mobile computer system of claim 12 further comprising:
a memory for storing physical data associated with the computer system comprising a first distance and a first direction with respect to a reference location, associated with the magnetometer;
wherein the processor is coupled to the memory; and
wherein the processor is programmed to determine the second rotation of the mobile computer system in response to the magnetometer data, first distance and the first direction.

20. The mobile computer system of claim 19
wherein the memory is for storing physical data associated with the computer system comprising a second distance and a second direction with respect to the reference location, associated with an accelerometer from the one or more accelerometers; and
wherein the processor is programmed to determine the first rotation of the mobile computer system in response to the accelerometer data, the second distance and the second direction.
